(19) United States
(12) Patent Application Publication
(10) Pub. No.: US 2019/0359075 A1
(43) Pub. Date: Nov. 28, 2019

(54) FUEL CELL BASED ELECTRIC VEHICLE DC FAST CHARGING SYSTEM AND FUEL CELL BASED ELECTRIC ENERGY STORAGE

(71) Applicant: Electric Motor Werks, Inc., San Carlos, CA (US)

(72) Inventor: Valery Miftakhov, San Carlos, CA (US)

(21) Appl. No.: 16/201,723

(22) Filed: Nov. 27, 2018

Related U.S. Application Data
(60) Provisional application No. 62/590,681, filed on Nov. 27, 2017.

(51) Int. Cl. B60L 53/54; H01M 8/0656; H01M 8/04082; H01M 16/00; H01M 10/44

(52) U.S. Cl. CPC B60L 53/54; H01M 8/0656; H01M 2220/20; H01M 16/003; H01M 10/44; H01M 8/04201

(57) ABSTRACT

In accordance with one aspect of the embodiments described herein, there is provided a hydrogen fuel cell based electric vehicle DC fast charging system. In various embodiments, the aforesaid hydrogen fuel cell based electric vehicle DC fast charging system could be implemented in a stationary or mobile deployment. The system includes a fuel cell, hydrogen storage and, optionally, an electrolyzer. The hydrogen fuel cell generates DC electrical energy for electrical vehicle charging using a supply of hydrogen provided by the hydrogen storage. An appropriate voltage converter may be optionally provided to convert the voltage of generated by the hydrogen fuel cell to voltage appropriate for charging a specific electric vehicle.

### CROSS-REFERENCE TO RELATED PATENT APPLICATION

This regular U.S. patent application relies upon and claims the benefit of priority from U.S. provisional patent application No. 62/590,681, entitled “FUEL CELL BASED ELECTRIC VEHICLE DC FAST CHARGING SYSTEM AND FUEL CELL BASED ELECTRIC ENERGY STORAGE,” filed on Nov. 27, 2017, which is incorporated by reference herein in its entirety.

### BACKGROUND OF THE INVENTION

### field of the invention

The disclosed embodiments relate in general to electric vehicle charging and electric energy storage technology, and, more specifically, to fuel cell based electric vehicle DC fast charging system and fuel cell based electric energy storage.

### Description of the Related Art

A fuel cell is an electrochemical cell that converts the chemical energy from a fuel into electricity through an electrochemical reaction of hydrogen fuel with oxygen or another oxidizing agent. Fuel cells are different from batteries in requiring a continuous source of fuel and oxygen (usually from air) to sustain the chemical reaction, whereas in a battery the chemical energy comes from chemicals already present in the battery. Fuel cells can produce electricity continuously for as long as fuel and oxygen are supplied.

The first fuel cells were invented in 1838. The first commercial use of fuel cells came more than a century later in NASA space programs to generate power for satellites and space capsules. Since then, fuel cells have been used in many other applications. Fuel cells are used for primary and backup power for commercial, industrial and residential buildings and in remote or inaccessible areas. They are also used to power fuel cell vehicles, including forklifts, automobiles, buses, boats, motorcycles and submarines.

There are many types of fuel cells, but they all consist of an anode, a cathode, and an electrolyte that allows positively charged hydrogen ions (protons) to move between the two sides of the fuel cell. At the anode a catalyst causes the fuel to undergo oxidation reactions that generate protons (positively charged hydrogen ions) and electrons. The protons flow from the anode to the cathode through the electrolyte after the reaction. At the same time, electrons are drawn from the anode to the cathode through an external circuit, producing direct current electricity. At the cathode, another catalyst causes hydrogen ions, electrons, and oxygen to react, forming water. Fuel cells are classified by the type of electrolyte they use and by the difference in startup time ranging from 1 second for proton exchange membrane fuel cells (PEM fuel cells, or PEMFC) to 10 minutes for solid oxide fuel cells (SOFC). Individual fuel cells produce relatively small electrical potentials, about 0.7 volts, so cells are “stacked”, or placed in series, to create sufficient voltage to meet an application's requirements. In addition to electricity, fuel cells produce water, heat and, depending on the fuel source, very small amounts of nitrogen dioxide and other emissions. The energy efficiency of a fuel cell is generally between 40-60%; however, if waste heat is captured in a cogeneration scheme, efficiencies up to 85% can be obtained.

Due to their light weight and high energy density, fuel cells could be used for electrical energy storage and for providing electric energy to electric vehicle fast charging stations. Therefore, novel systems and methods enabling such uses are needed.

### SUMMARY OF THE INVENTION

The inventive methodology is directed to methods and systems that substantially obviate one or more of the above and other problems associated with conventional electric vehicle charging technology.

In accordance with one aspect of the embodiments described herein, there is provided a hydrogen fuel cell based electric vehicle DC fast charging system comprising: a hydrogen storage for storing a supply of hydrogen; a fuel cell coupled to the hydrogen storage for generating DC electrical energy for an electrical vehicle charging using the supply of hydrogen provided by the hydrogen storage; and an electrolyzer for producing hydrogen for storing in the hydrogen storage.

In one or more embodiments, the hydrogen fuel cell based electric vehicle DC fast charging system further comprises a voltage converter for converting the voltage of the DC electrical energy generated by the hydrogen fuel cell to voltage appropriate for charging the electric vehicle.

In one or more embodiments, the hydrogen fuel cell based electric vehicle DC fast charging system further comprises a vehicle chassis for achieving mobility.

In one or more embodiments, the hydrogen fuel cell based electric vehicle DC fast charging system further comprises stationary installation components.

In accordance with another aspect of the embodiments described herein, there is provided a method for furnishing a hydrogen fuel cell based electric vehicle DC fast charging comprising: providing a hydrogen storage for storing a supply of hydrogen; providing a fuel cell coupled to the hydrogen storage for generating DC electrical energy for an electrical vehicle charging using the supply of hydrogen provided by the hydrogen storage; and providing an electrolyzer for producing hydrogen for storing in the hydrogen storage.

In one or more embodiments, the method further comprises providing a voltage converter for converting the voltage of the DC electrical energy generated by the hydrogen fuel cell to voltage appropriate for charging the electric vehicle.

In one or more embodiments, the method further comprises providing a vehicle chassis for achieving mobility.

In one or more embodiments, the method further comprises providing stationary installation components.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates an exemplary embodiment of a hydrogen fuel cell based electric vehicle DC fast charging system and an exemplary embodiment of a hydrogen fuel cell based electric energy storage.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense.

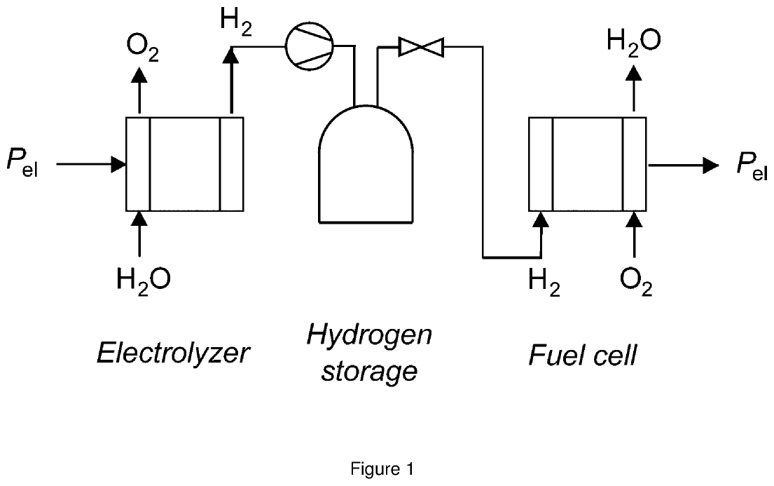

In accordance with one aspect of the embodiments described herein, there is provided a hydrogen fuel cell based electric vehicle DC fast charging system. In various embodiments, the aforesaid hydrogen fuel cell based electric vehicle DC fast charging system could be implemented in a stationary or mobile deployment. FIG. 1 illustrates an exemplary embodiment of a hydrogen fuel cell based electric vehicle DC fast charging system. The shown system includes a fuel cell, hydrogen storage and, optionally, an electrolyzer. The hydrogen fuel cell generates DC electrical energy for electrical vehicle charging using a supply of hydrogen provided by the hydrogen storage. An appropriate voltage converter, such as buck converter well known in the art, may be optionally provided to convert the voltage of generated by the hydrogen fuel cell to voltage appropriate for charging a specific electric vehicle.

The hydrogen may be generated using the shown electrolyzer, which generates hydrogen gas using electric energy and water. The generated hydrogen is stored in the hydrogen storage. In various embodiments, the system may be deployed in a mobile configuration, such as a trailer, or in a stationary configuration.

In accordance with another aspect of the embodiments described herein, there is provided a hydrogen fuel cell based electric energy storage. The aforesaid embodiments has a configuration substantially similar for the configuration shown in the FIG. 1.

The shown system includes a fuel cell, hydrogen storage and, optionally, an electrolyzer. In addition, a battery, such as a lithium battery, or a supercapacitor may be provided to achieve fast demand response. The hydrogen fuel cell generates DC electrical energy for using a supply of hydrogen provided by the hydrogen storage. An appropriate voltage converter may be optionally provided to convert the voltage of generated by the hydrogen fuel cell to AC voltage of the house power supply.

The hydrogen may be generated using the shown electrolyzer, which generates hydrogen gas using electric energy and water. The generated hydrogen is stored in the shown hydrogen storage. In various embodiments, the system may be deployed in a mobile configuration, such as a trailer, or in a stationary configuration

In addition, a battery, such as a lithium battery, or a supercapacitor may be provided to achieve fast demand response. In various embodiments, the battery or supercapacitor is connected to the shown system using an appropriate power circuitry.

In various embodiments, the fuel cell may be implemented using any known or future developed fuel cell technology. In various embodiments, the electrical energy received by the electrolizer may be supplied by one or more green energy generators, such as solar panels or wind turbines. In one embodiments, the solar panels are placed on a roof of vehicle parking lot.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive.

Moreover, other implementations of the invention will be apparent to those skilled in the art from consideration of the specification and practice of the invention disclosed herein. Various aspects and/or components of the described embodiments may be used singly or in any combination in systems and methods for electric vehicle charging with automated trip planning integration. It is intended that the specification and examples be considered as exemplary only, with a true scope and spirit of the invention being indicated by the following claims.

What is claimed is:

1. A hydrogen fuel cell based electric vehicle DC fast charging system comprising:
a. a hydrogen storage for storing a supply of hydrogen;
b. a fuel cell coupled to the hydrogen storage for generating DC electrical energy for an electrical vehicle charging using the supply of hydrogen provided by the hydrogen storage; and
c. an electrolyzer for producing hydrogen for storing in the hydrogen storage.

2. The hydrogen fuel cell based electric vehicle DC fast charging system of claim 1, further comprising a voltage converter for converting the voltage of the DC electrical energy generated by the hydrogen fuel cell to voltage appropriate for charging the electric vehicle.

3. The hydrogen fuel cell based electric vehicle DC fast charging system of claim 1, further comprising a vehicle chassis for achieving mobility.

4. The hydrogen fuel cell based electric vehicle DC fast charging system of claim 1, further comprising stationary installation components.

5. A method for providing a hydrogen fuel cell based electric vehicle DC fast charging comprising:
a. providing a hydrogen storage for storing a supply of hydrogen;
b. providing a fuel cell coupled to the hydrogen storage for generating DC electrical energy for an electrical vehicle charging using the supply of hydrogen provided by the hydrogen storage; and
c. providing an electrolyzer for producing hydrogen for storing in the hydrogen storage.

6. The method of claim 5, further comprising providing a voltage converter for converting the voltage of the DC electrical energy generated by the hydrogen fuel cell to voltage appropriate for charging the electric vehicle.

7. The method of claim 5, further comprising providing a vehicle chassis for achieving mobility.

8. The method of claim 5, further comprising providing stationary installation components.
